(19) United States
(12) Patent Application Publication
(10) Pub. No.: US 2012/0047017 A1
(43) Pub. Date: Feb. 23, 2012

(54) IN-GAME ADVERTISING

(75) Inventors: Joshua Hernandez, Chicago, IL (US); William Guschwan, Evanston, IL (US); Justin C. Moore, River Forest, IL (US)

(73) Assignee: Tap Me, Inc., Chicago, IL (US)

(21) Appl. No.: 13/178,363

(22) Filed: Jul. 7, 2011

Related U.S. Application Data
(60) Provisional application No. 61/362,610, filed on Jul. 8, 2010.
(60) Provisional application No. 61/370,412, filed on Aug. 3, 2010.

(51) Int. Cl. G06Q 30/02

(52) U.S. Cl. 705/14.55; 705/14.49; 705/14.58

(57) ABSTRACT

Disclosed is a platform that provides innovative advertising space to businesses by engaging gamers to create viral loops for brands. The platform features unique components including: 1) game developers have real-time control over advertising content and 2) gamers will associate an actual gaming accomplishment with a positive brand interaction (e.g. when a gamer achieves a high score, they will see a message that associates the accomplishment with an advertiser). The platform may be expanded on a global scale through offers of software development kits that allow other game developers to integrate the platform into their own mobile and Web games. Gamers, game developers, and advertisers will be able to track user data produced by the system if each gamer and developer agrees to do so.

### CROSS-REFERENCE TO RELATED APPLICATIONS

This application claims priority to U.S. Provisional Patent Application No. 61/362,610, filed on Jul. 8, 2010, and entitled IN-GAME ADVERTISING PLATFORM, and U.S. Provisional Patent Application No. 61/370,412, filed on Aug. 3, 2010, and entitled IN-GAME ADVERTISING PLATFORM, both of which are incorporated herein by reference.

### FIELD OF THE INVENTION

At least one embodiment of the present invention pertains to mobile gaming, and more specifically to providing in-game advertising to players of mobile games.

### SUMMARY

With the success of mobile gaming platforms such as the iPhone, iPad, Android and the Sony PlayStation Portable, a new market has emerged—mobile gamers that need an affordable, constant supply of new game experiences, unified communities and services. The techniques introduced here include a system and method for implementing an in-game advertising platform. This advertising solution allows sales generation and game logic to converge successfully, thereby creating a mutually beneficial solution for both advertisers and gamers. The platform creates an integrated mobile gaming community that helps the application developers promote their own products and establishes profitable relationships with advertisers and other game developers. The platform delivers a new in-game advertising method that benefits both advertisers and gamers. In addition, the platform alleviates loss from digital piracy by monetizing the gaming experience.

The platform provides innovative advertising space to businesses by engaging gamers to create viral loops for brands. The platform features unique components including: 1) game developers have real-time control over advertising content and 2) gamers will associate an actual gaming accomplishment with a positive brand interaction (e.g. when a gamer achieves a high score, they will see a message that associates the accomplishment with an advertiser). The platform may be expanded on a global scale through offers of software development kits that allow other game developers to integrate the platform into their own mobile and Web games. Gamers, game developers, and advertisers will be able to track user data produced by the system if each gamer and developer agrees to do so.

Other aspects of the techniques summarized above will be apparent from the accompanying figures and from the detailed description which follows.

### BRIEF DESCRIPTION OF THE DRAWINGS

One or more embodiments of the present invention are illustrated by way of example and not limitation in the figures of the accompanying drawings, in which like references indicate similar elements.

FIG. 1 is a flow diagram of an example of a system implementing the in-game marketing techniques introduced here.

FIG. 2 is a flow diagram depicting the matching process according to an embodiment of the techniques introduced here.

FIG. 3 is a flow diagram of an example process for presenting matched sponsors to players in a game.

FIG. 4 is a flow diagram of a process performed by the in-game marketing system to determine which sponsors to display for player selection.

FIG. 5 is a sample screenshot of a game screen including an achievement window which includes a sponsor brand label.

FIG. 6 is a sample of in-application sponsorship screens.

FIG. 7 is a sample of in-application achievement screens.

FIG. 8 is a sample of system user screens.

FIG. 9 is a sample of system back-end screens.

FIG. 10 is a flow chart of the system Advertiser to Game Data Model.

FIG. 11 is a flow chart of the system Matching Process.

FIG. 12 is a flow chart of the system sponsor search model.

FIG. 13 is an example block diagram of a system employing the techniques introduced here.

### DETAILED DESCRIPTION

References in this specification to “an embodiment”, “one embodiment”, or the like, mean that the particular feature, structure or characteristic being described is included in at least one embodiment of the present invention. Occurrences of such phrases in this specification do not necessarily all refer to the same embodiment.

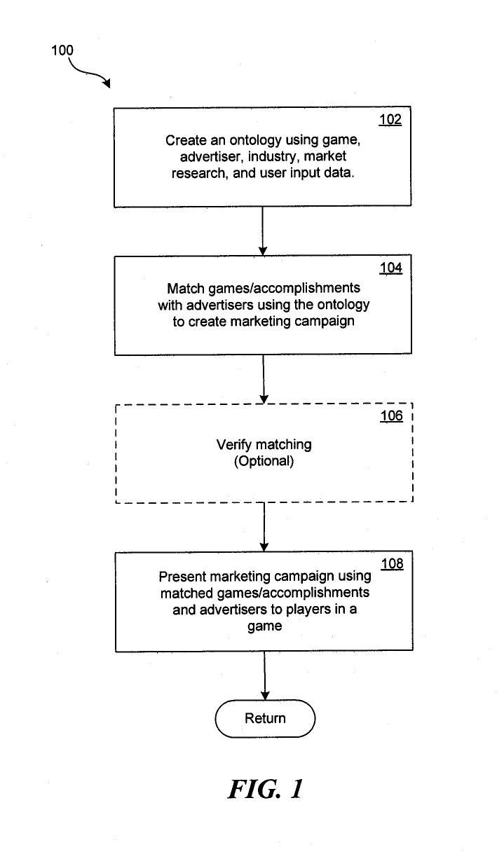

FIG. 1 is a flow diagram of an example of a system implementing the marketing techniques introduced here. The process begins at 102 with the system creating an ontology using game, advertiser, game industry, market research, and user activity data. The ontology is created using known methods and data gathered from the above mentioned sources.

Game data can include the game files, a game description, and accomplishments. The game description can further include the genre of the game, subject matter categories, the platform for which the game was developed, and the target market for the game. Advertiser data, e.g., campaign information, can include campaign files, a campaign description, and the campaign duration. The campaign description can further include industry categories, keywords, target markets and business goals. Game industry data can include genre keywords, genre target market maps, release and localization of games, genre user geo-location data, game player demographics, and game design elements map.

User activity data can be obtained by tracking what games, or genre of games, a type of user is playing. User activity data can also include data regarding a user's interaction with advertisements that have been displayed. In one embodiment, user surveys can be gathered and the data obtained from the user surveys can be used in building the ontology. Similarly, market research, performed by the game developer, an advertiser, or a third party research company can be included in the ontology.

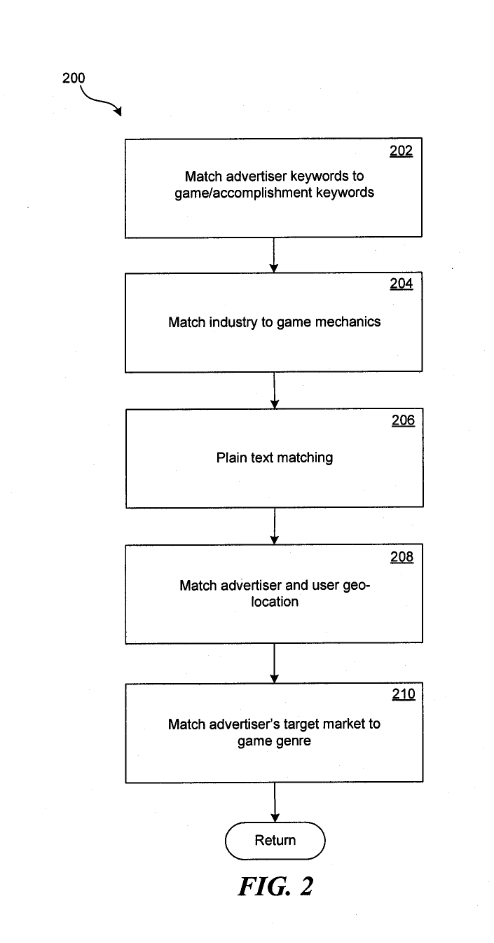

At 104, the system matches games, in-game accomplishments, and/or game design elements to advertisers or specific advertisements in order to create a marketing campaign that can be presented to players of the game. The advertiser/advertisement can be matched to games, in-game accomplishments, and/or game design elements based on characteristics of a product or brand that correspond to characteristics of the game, the in-game accomplishment, or the game design element. For example, Gatorade markets sports drinks that increase endurance which can be matched to the game design element of how long or how fast an avatar in the game can sprint. The matching process is described in further detail below with reference to FIG. 2.

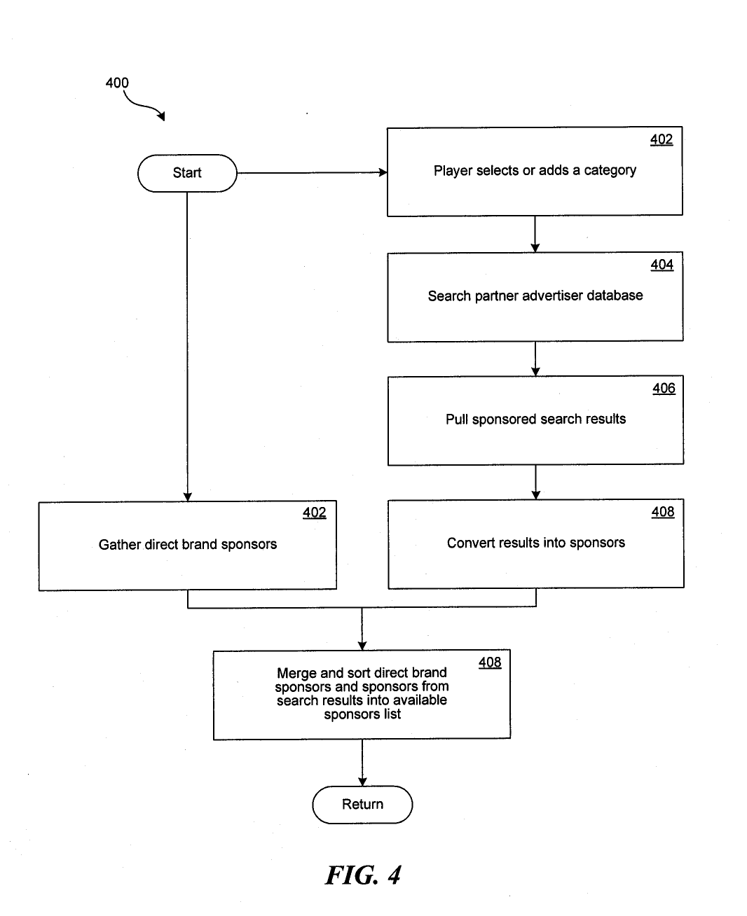

Once the system has matched the games/accomplishments to the brands or products according to common characteristics, the matching can optionally be verified by an administrator at 106 prior to presenting the marketing campaign to players. If this optional step is not taken, the unverified matches are presented as a marketing campaign to the players of the game at 108. The marketing campaign can be presented to the players in various forms. In one embodiment, players choose to be sponsored by a particular product/brand and are given an advantage based on the characteristics of the product/brand. Sponsorship is discussed below with reference to FIG. 4.

FIG. 2 is a flow diagram depicting the matching process according to an embodiment of the techniques introduced here. At 202 games and products are matched according to keywords. For example, if a product has strength in its title or description then it can be matched with an accomplishment or a game design element for strength.

The process continues with 204 where the system matches industry/advertiser attributes to game mechanics. Industry/advertiser attributes can include a brand attribute or a product attribute, for example, the brand Gatorade is associated with the attributes of athleticism, endurance, and strength, among other attributes. Game mechanics include a description of how elements of the game design are implemented. For example, the game mechanics that describe an avatar can include how fast the avatar can run, a health score, or special abilities. Objects in a game can also have game mechanics associated with them. For example, a suit of armor can increase the health score of an avatar that is equipped with the armor. Industry/advertiser attributes can be matched with game mechanics to give the player of a game a benefit that corresponds to the industry/advertiser attributes. For example, the brand attributes of Gatorade as described above can be matched with the game mechanics of an avatars health score. If a player then selects Gatorade as a sponsor of the game, the health score of the player's avatar can be increased. Players gain a positive association with the brand because of the gain they have received and therefore become a stronger brand advocate.

At 206, plain text matching can be used to further improve game and advertiser matching. Plain text elements included in the game design can be matched to keywords or elements of a advertiser's campaign. There are many plain text elements of game design, for example, the game script, object metadata, avatar descriptions, etc. A red box element of a game, which includes the words “red box” in the metadata, can be matched to the retailer/advertiser Redbox™ with a high relevancy score. Similarly, if the metadata includes a description of the red box's behavior, for example, “explodes on contact”, the description can be matched to a retailer/advertiser Pop Rocks as well.

The geo-location of advertisers and players of the game are matched at 208. One source of player geo-location is the physical location of the device used to play the game. Various methods for determining the devices location can be used, for example, GPS location data, the device's IP address, cellular signal data, etc. The location of players can also be determined based on game industry data or player input data. For example, if it is known that a large number of people in New York are playing a particular game, then advertisers with a large market in New York would be a good geo-location match. A player may also be asked for location information on a voluntary basis, for example, the player may be asked to input their postal zip code. Other sources of geo-location data can also be used to provide good game/achievement matching with advertisers.

Finally, at 210, target market data is used to match advertisers with games. Target market data can also be used to improve matches already made between advertisers and games. The target market data can include both target markets for the advertisers and the game and those target markets can be matched. In one embodiment, advertiser target market data can be matched to other game features, for example, a game genre.

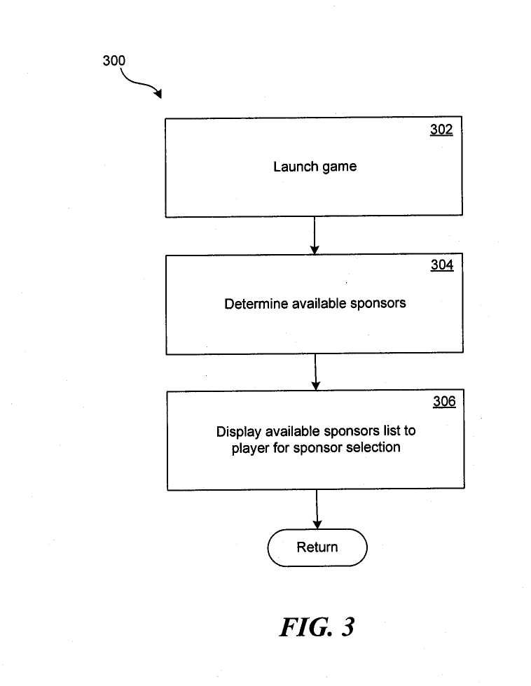

FIG. 3 is a flow diagram of an example process for presenting matched sponsors to players in a game. The process begins when a player launches the game at 302. At 304 the system determines available sponsors and then at 306 displays a list of the available sponsors to the player for selection. The process of determining available sponsors is described in further detail with respect to FIG. 4. The sponsors can be listed for the player upon launch or they can be found in a sponsors list in the player's profile, for example. However they are presented, the player can select sponsors from the list. Sponsorship from an advertiser provides a player with benefits otherwise not available in the game. For example, additional content can be unlocked, skill can be increased, and special items can be used by the player when they have a sponsor.

The player by associating with a sponsor becomes a brand advocate for advertisers in the game. The sponsor can be displayed along accomplishments achieved by the player on the player's social networks providing targeted advertising to the player's friends. Input and output data from the player's social network can be leveraged to further the player/sponsor relationship. For example, a player can recruit other players through his/her social network on behalf of the brand/sponsor and gain additional rewards. The relationship between the player and the sponsor can also be used to provide targeted advertising to the player and the other visitors to the player's social networking page. To further help foster the player/sponsor relationship, in-game features can be increased over time as the player progresses through the game and the player/sponsor relationship is strengthened.

FIG. 4 is a flow diagram of a process performed by the in-game marketing system to determine which sponsors to display for player selection. The process 400 begins at 402 with the player selecting a category. The category can be chosen from a list presented to the user or the category can be added by the user. For example, a player can choose to see sponsors related sports drinks. The process continues at 404 where the system searches a partner advertising database for sponsors that are related to the category chosen by the player. Multiple databases can be searched to provide a wide variety of potential sponsors for the player. At 406 search results that match the category chosen by the player are pulled from the database. Continuing with the sports drink category example from above, advertisements for sports drink companies or retailers that sell sports drinks, for example, could be pulled from the partner advertising database.

At 408 the search results are sent to the in-game advertising platform and the results are converted into sponsors. The conversion of search results pulled from the partner advertising database to sponsors can include the matching process described above. Thus, the products or brands pulled from the database can be implemented into the in-game marketing environment.

As part of the in-game advertising system a group of direct brand sponsors are displayed to the user regardless of the category chosen. At 410 these direct brand sponsors are gathered. The direct brand sponsors can be stored locally to the central in-game advertising server or can be stored in a brand sponsor database at another location. At 412 the direct brand sponsors and the sponsors created from the search results are merged into a list of the sponsors available for the player to select from.

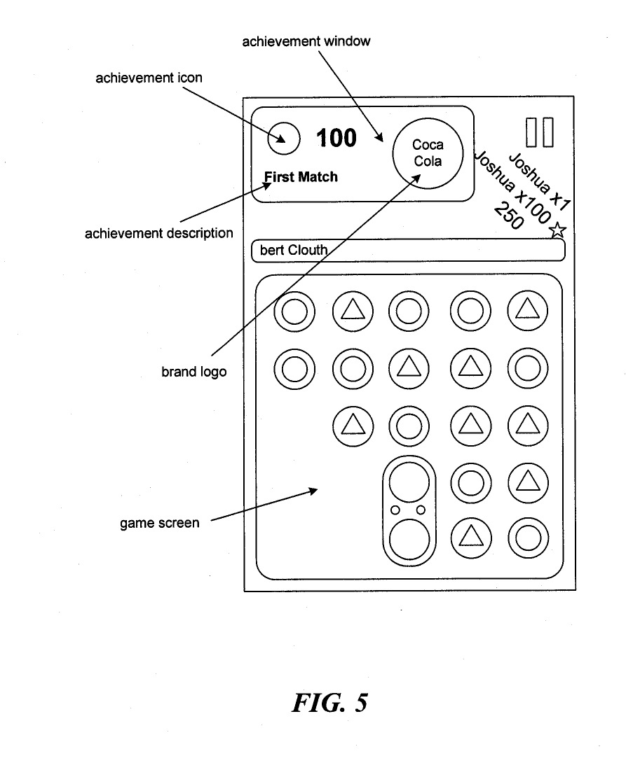

FIG. 5 is a sample screenshot of a game screen including an achievement window. The achievement window includes an achievement icon, an achievement description and a brand logo. In one embodiment, the brand logo can be associated with the achievement. For example, Coca Cola sponsors an achievement that has attributes similar to attributes of the Coca Cola brand. In another embodiment, the brand logo can be the player's sponsor brand logo. Upon receiving the achievement the player can post the achievement, along with the brand logo, to his/her social network thereby becoming an advocate for the brand.

In one embodiment the brand logo featured in the achievement window of the game screen is interactive to the player. When the player interacts with the logo additional features or benefits can be obtained by the player. For example, when the player taps on the Coca Cola icon a reward coupon from the sponsor can be made available to the player. The reward coupon will encourage the player to make a purchase of the sponsor's products. Additionally, greater in-game benefits can be granted to a player for interacting with the brand logo in the achievement window. The above examples are not meant to be limiting and any benefit can be granted to the player for interacting with the brand logo. This interaction creates a favorable impression of the brand with the player and encourages the player to either purchase or recommend the brand products.

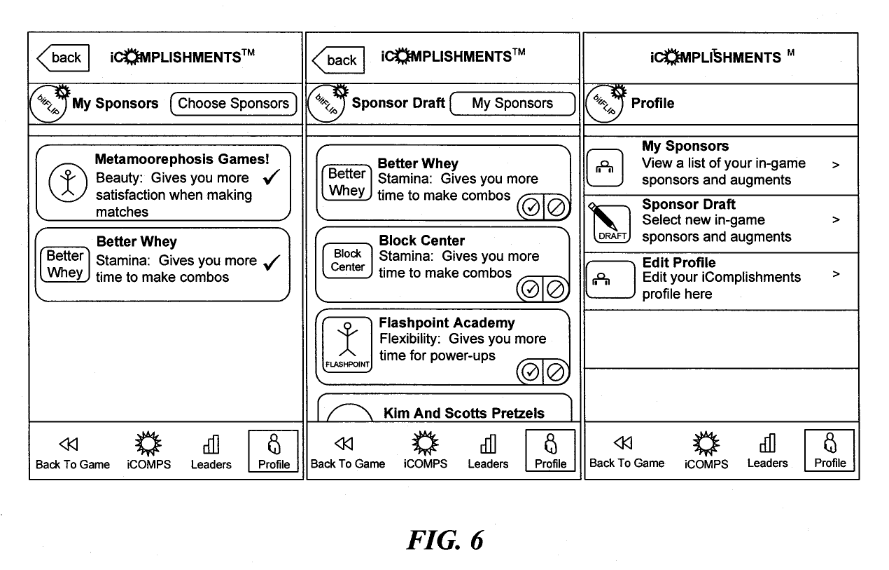

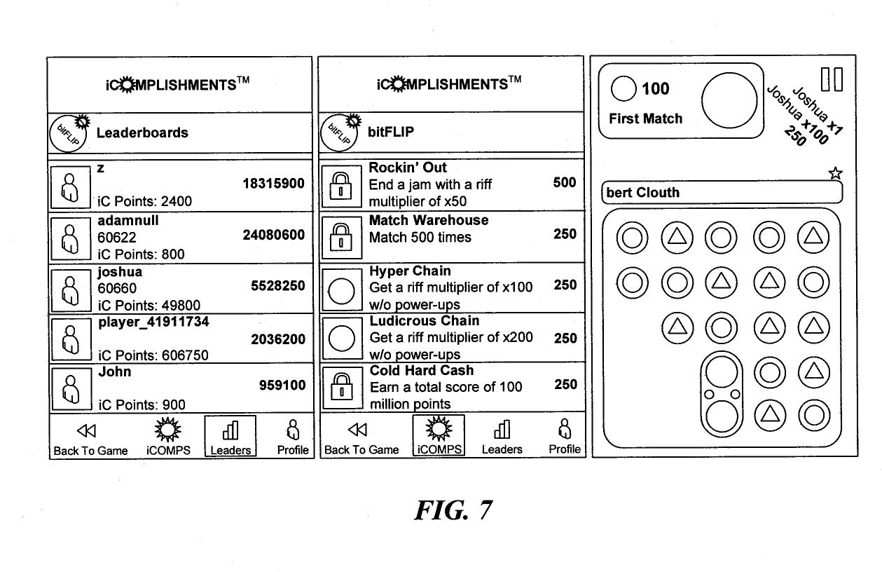

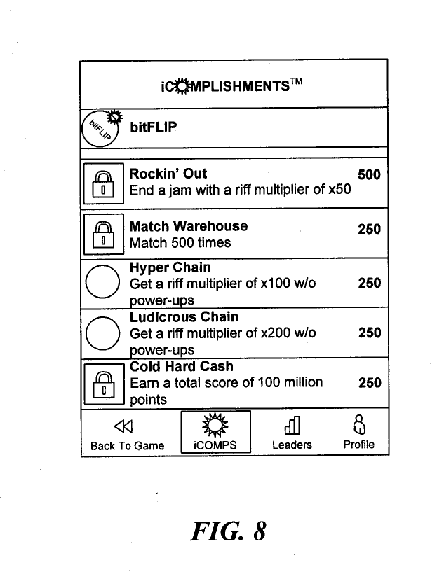

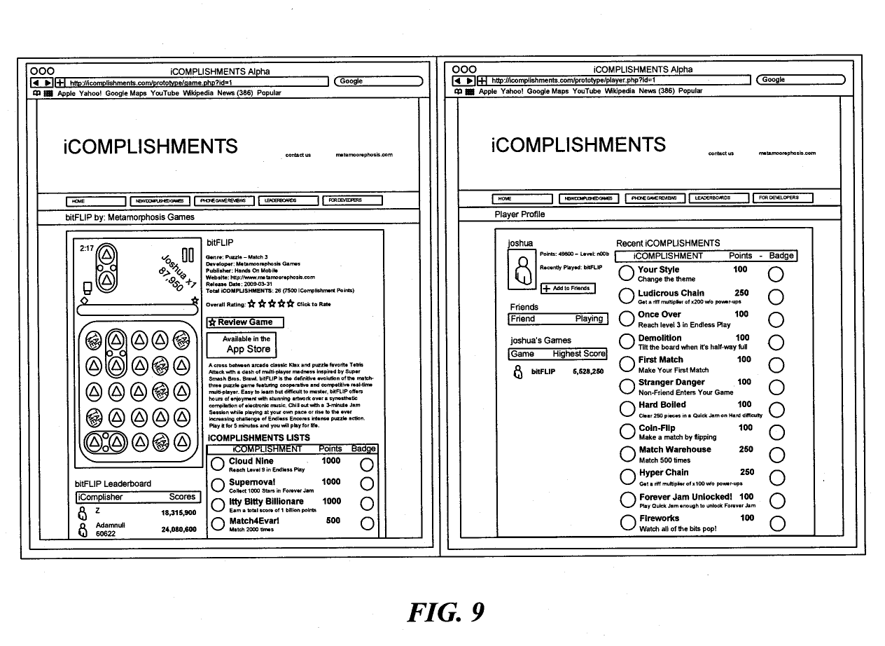

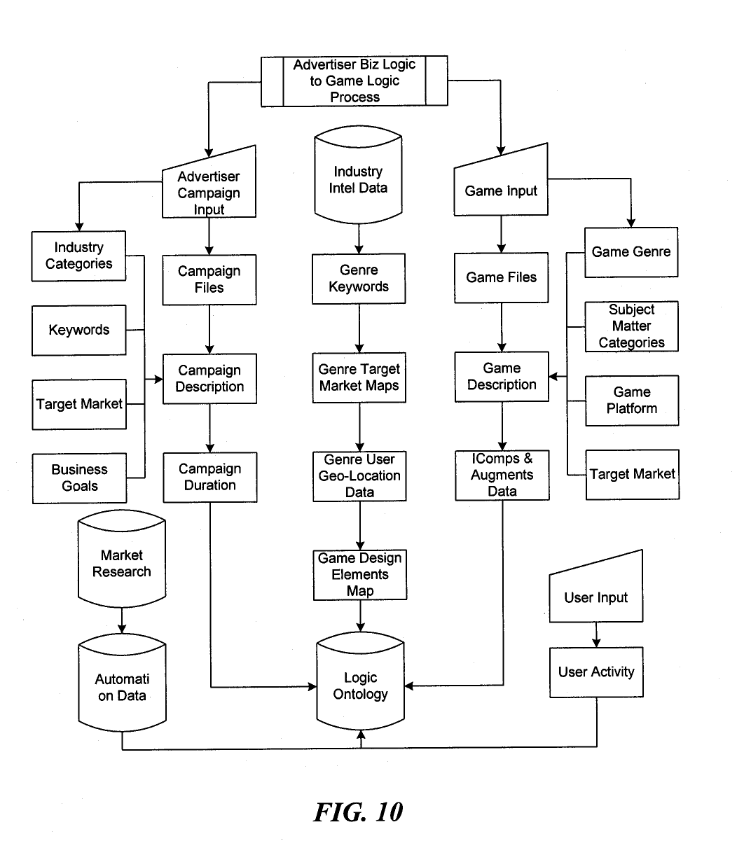

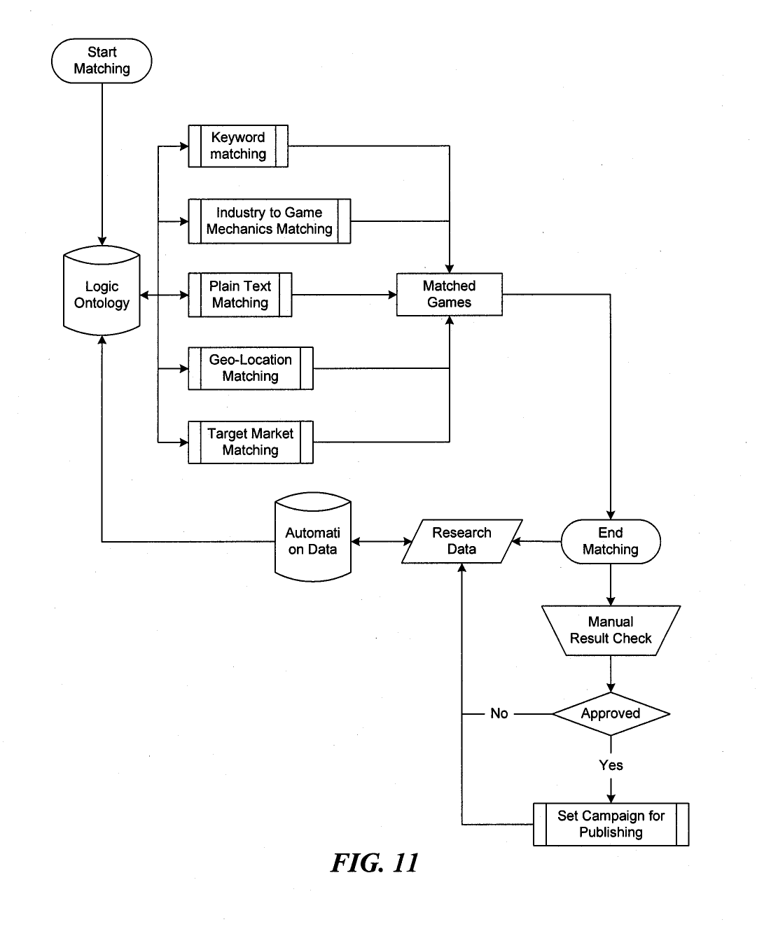

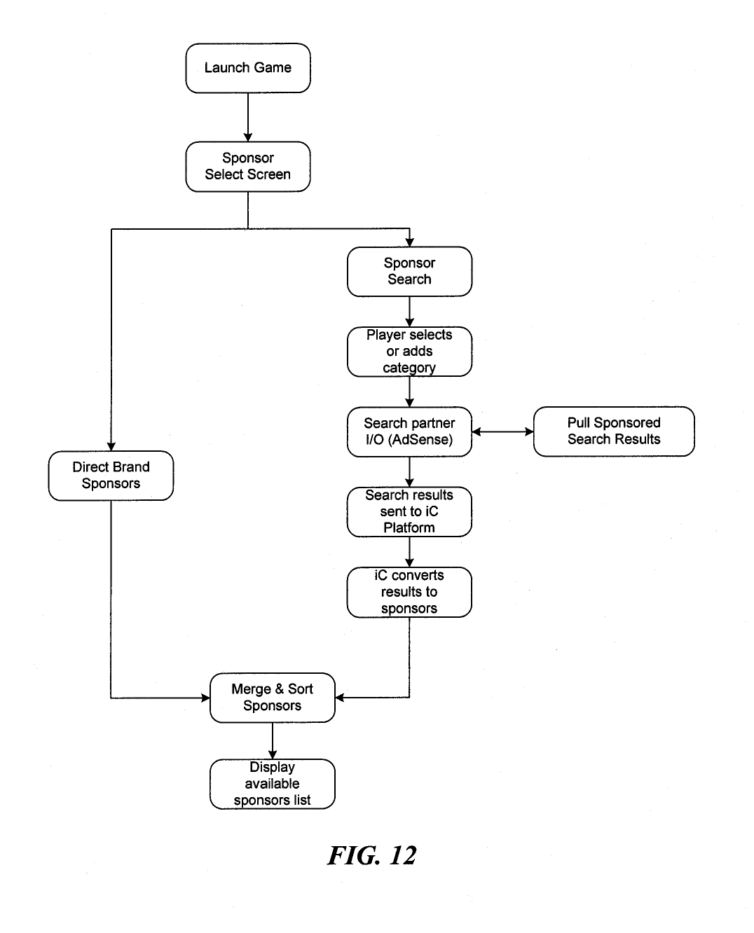

The system and techniques described here offer a robust in-game advertising service that connects gaming communities via a meta-game service (see FIGS. 6-12). The system and techniques include an advertising platform that is served as a game that sits on top of other games for smart phones and Flash and Windows games such as but not limited to the iPhone, Android, Xbox Achievements, and PS3 Trophies. The service allows players to globally keep track of progress in games, connect with friends and aggregate data to popular services like Facebook and Twitter.

The service introduces a new in-game advertising delivery method that is driven by the in-game rewards system. This system is based on proven services such as but not limited to Xbox Live Achievements and PlayStation Trophies, which give virtual bragging rights to gamers around the world.

The system and techniques include a unique sponsorship system that converts traditional banner advertisers into sponsors that players may select and manipulate. The players act as brand advocates for advertisers in the game and those advertisers will be included in aggregate data that is pushed to the users' social networks. In return, sponsors will unlock in-game benefits like currency, special items, game levels and other game-centric objects. To provide an incentive for players to foster better player-sponsor relationships, there is a feature in the system that increases in-game benefits to the player over time.

The system and techniques include a web portal to complement the unique in-game experience as described above. This portal allows developers to change their in-game achievements and sponsors in real time as well as participate in an ad-revenue sharing program that lets sponsors purchase sets of achievements that carry their brands.

The system further includes a set of social marketing tools meant to integrate the in-game user interactions with social networks such as, but not limited to, Twitter and Facebook. The website serves as an environment where sponsors may send users to participate in marketing outreach like contests and surveys. Marketers may ask a user to pass on the message to that user's social network.

This service offers innovation for in-game advertising by associating brands with positive moments in a player's life. This feature allows developers to look beyond the initial sale of their games and even extend the life of the game by offering players more to do in the game over time. Users may connect their account with their social networks to further their game playing bragging rights while spreading advertisements from their sponsors.

In one embodiment, the system exposes an API that allows other developers to integrate the system and techniques described here into their products. The API may be distributed freely to developers along with an offer to subscribe to advanced data analysis provided by the system, which provides them with a new level of consumer intelligence regarding their games. This business model caters to current developers' needs for low or no cost solutions subsidized by this ad-revenue based plan. The API may reach all mobile platforms as well as browser-based video games.

In one embodiment, the system further includes a customer facing application for mobile devices that collects the players' achievement and sponsor data in one place, allows them to set personal achievements and discover new apps via a ‘You Should Playlist’ (or other like named) list service. This application in later stages may become a live event coordination application. For example the customer facing application may serve functions at tradeshows and encourage people to visit exhibitor booths for points.

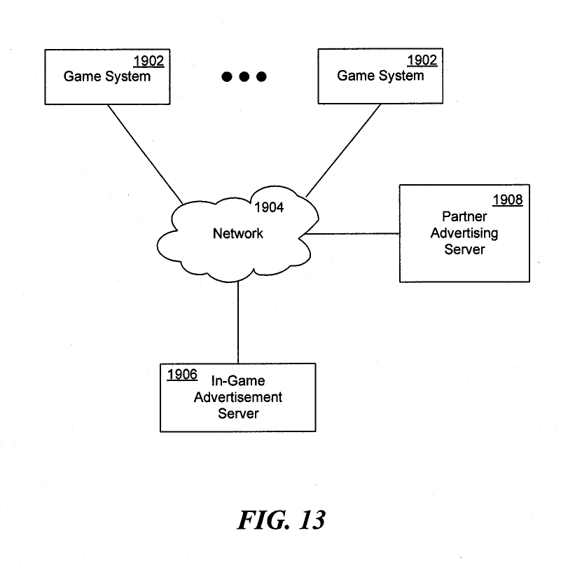

FIG. 13 is an example block diagram of a system employing the techniques introduced here. The system includes a game system 1902 attached to a network 1904. An in-game advertisement server 1906 and a partner advertising server 1908 are also connected to the network. Communication between the various game systems and servers takes place over the network 1904. The network can be a packet-switched network, for example, a local area network (LAN) or wide area network (WAN), a public network (e.g., the Internet) a virtual private network implemented over a public network, or any other network configuration suitable for transmitting data between the components of the system.

When a player initially begins a game on the game system 1902, the game system connects to the in-game advertisement server 1906 to provide a list of sponsors that the player can choose from. As part of preparing the sponsor list, as described above, the in-game advertisement server 1906 connects with partner advertising server 1908 to provide additional sponsors in a category chosen by the player.

When the player has reached an achievement, the game system 1902 can post a notification of the achievement along with the sponsor's information to a server hosting the player's social networks (not shown).

The techniques introduced above can be implemented by programmable circuitry programmed or configured by software and/or firmware, or they can be implemented by entirely by special-purpose “hardwired” circuitry, or in a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware for implementing the techniques introduced here may be stored on a machine-readable storage medium and may be executed by one or more general-purpose or special-purpose programmable microprocessors. A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc.

The term “logic”, as used herein, can include, for example, special-purpose hardwired circuitry, software and/or firmware in conjunction with programmable circuitry, or a combination thereof.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A method for providing in-game advertisements, the method comprising:
creating an ontology including at least one of: user data, market research data, advertiser data, game industry data, or game design data;
matching game attributes with advertisers using the ontology; and
presenting the advertisers to a player such that the player can choose a sponsor advertiser to sponsor the player during a game.

2. The method of claim 1 further comprising, providing a game benefit to the player in response to the player selecting a sponsor advertiser.

3. The method of claim 1 further comprising, displaying an indication of the sponsor advertiser along with player achievements.

4. The method of claim 3, wherein the indication of the sponsor advertiser and the player achievements are displayed on a social network.

5. The method of claim 1 further comprising:
displaying sponsor categories to the player;
displaying, in response to the player selecting a sponsor category, available sponsors in the sponsor category;
receiving a selection of the sponsor advertiser from the user; and
associating the user and user achievements with the sponsor advertiser.

6. The method of claim 1, wherein matching game attributes with advertisers includes:
matching advertiser keywords with game keywords; and
matching advertiser attributes with game mechanics.

7. The method of claim 6, wherein matching game attributes with advertisers further includes:
determining the geo-location of the player; and
matching advertisers based on the geo-location.

8. A method for providing in-game advertisements, the method comprising:
displaying an achievement window to a player in response to the player accomplishing an achievement during a game;
displaying a sponsor brand logo in the achievement window, wherein the sponsor brand logo is related to the achievement; and
providing a benefit to the player in response to the player interacting with the sponsor brand logo displayed in the achievement window.

9. The method of claim 8, wherein the achievement window includes an achievement icon or an achievement description.

10. The method of claim 8 further comprising, matching the sponsor brand logo with the achievement based on an ontology including game and advertiser data.

11. The method of claim 10, wherein matching the sponsor brand logo with the achievement includes:
matching advertiser keywords with achievement keywords; and
matching advertiser attributes with game mechanics.

12. The method of claim 11, wherein matching the sponsor brand logo with the achievement further includes:
determining the geo-location of the player; and
matching the sponsor brand logo based on the geo-location.

13. The method of claim 8 further comprising:
presenting advertisers to a player such that the player can choose a sponsor advertiser to sponsor the player during a game; and
providing a game benefit to the player in response to the player selecting the sponsor advertiser.

14. The method of claim 8, wherein displaying the sponsor brand logo includes displaying the sponsor brand logo along with the achievement on a social network.

15. The method of claim 13, wherein presenting advertisers to a player includes:
displaying sponsor categories to the player;
displaying, in response to the player selecting a sponsor category, available sponsors in the sponsor category;
receiving a selection of the sponsor advertiser from the user; and
associating the user and user achievements with the sponsor advertiser.

16. A system comprising:
a processor; and
a memory coupled with the processor, the memory storing instructions which when executed by the processor cause the system to perform a plurality of operations, including:
displaying, in response to an achievement of a player, a sponsor brand logo related to the achievement; and
providing a benefit to the player in response to the player interacting with the sponsor brand logo displayed in the achievement window.

17. The system of claim 16, wherein the plurality of operations further includes displaying an achievement window to the player in response to the player accomplishing the achievement, the achievement window including the sponsor brand logo.

18. The system of claim 16, wherein the plurality of operations further includes determining the sponsor brand logo is related to the achievement by:
creating an ontology including at least one of: user data, market research data, advertiser data, game industry data, or game design data; and
matching the achievement with the sponsor brand logo based on the ontology.

19. The system of claim 18, wherein determining the sponsor brand logo is related to the achievement further includes:
determining the geo-location of the player; and
matching the sponsor brand logo based on the geo-location.

20. The system of claim 16, wherein plurality of operations further includes, presenting advertisers to a player such that the player can choose a sponsor advertiser to sponsor the player during a game.

21. The system of claim 20, wherein plurality of operations further includes, providing a game benefit to the player in response to the player selecting the sponsor advertiser.

22. The system of claim 16, wherein displaying the sponsor brand logo related to the achievement includes displaying the sponsor brand logo along with the achievement on a social network.

23. The system of claim 20, wherein presenting advertisers to a player includes:
displaying sponsor categories to the player;
displaying, in response to the player selecting a sponsor category, available sponsors in the sponsor category;
receiving a selection of the sponsor advertiser from the user; and
associating the user and user achievements with the sponsor advertiser.
